(19) United States
(12) Patent Application Publication
(10) Pub. No.: US 2012/0325934 A1
(43) Pub. Date: Dec. 27, 2012

(54) MANUALLY OPERABLE SPRAY GUN FOR PROVIDING A VARIABLE SPRAY PATTERN

(76) Inventors: John D. DeLorme, Spencerport, NY (US); Ronald M. Odessa, Batavia, NY (US); Thomas J. Wilkinson, Alden, NY (US)

(21) Appl. No.: 13/532,200

(22) Filed: Jun. 25, 2012

Related U.S. Application Data
(60) Provisional application No. 61/571,244, filed on Jun. 23, 2011.

(51) Int. Cl. B05B 11/00

(52) U.S. Cl. 239/526

(57) ABSTRACT

A manually operable spray gun which provides a variable spray pattern of liquid passing through the gun from a source of pressurized liquid. A valve spool is reciprocally movable in opposite directions by a pivotally mounted trigger. One spool end has a valve which closes flow through the spool; the other spool end is a flow control element having a flow control surface. The spool can be moved from a position where the valve controlling the flow into the spool is closed to a position where the valve is open and the spacing between the flow control element and the nozzle is varied. By varying this spacing, liquid flow can be varied from flowing directly to a nozzle orifice to flowing along the interior conical surface of the nozzle. The diameter of the conical pattern may be varied by changing the spacing between the flow control element and the nozzle.

Priority is claimed to U.S. Provisional Application No. 61/571,244, filed Jun. 23, 2011, which is herein incorporated by reference.

The present invention relates to spray guns and particularly spray guns which provide a variable spray pattern.

Manually spray guns heretofore utilize a rotatable nozzle in order to vary the spray pattern there from. See for example, U.S. Pat. No. 5,183,322, issued Feb. 2, 1993 to James Haruch. Other spray guns have used manually actuable trigger levers. See for example, U.S. Pat. No. 4,541,568, issued Sep. 17, 1985 to William Lichfield.

Adjustable nozzles have a drawback in that spraying liquid may contact the hands of the user. Many times such liquids are toxic, and such hand contact is not desired. It is also desirable to provide a variable spray pattern using a trigger lever in a manually gripable handle. However, the control of the spray from a shutoff to a pattern which may either be a stream, or a conical pattern of variable diameter has not been achievable in lever operated spray guns. In other words, ergonometric considerations respecting spray guns are that the spray guns control the spraying action by being capable of shutting of flow, i.e., stopping the spray, and readily selecting the spray pattern whether the pattern desired is a stream, a conical spray pattern or a spray pattern including both stream and conical patterns.

Accordingly, it is the principal object of the present invention to provide an improved spray gun which is trigger actuable and also be operated manually.

Is it a further object of the invention to provide a trigger lever operated spray gun having a selectable spray pattern which may be a pattern in the form of a stream or patterns of conical shape of desired diameter which conical patterns may include a stream.

Briefly described, a manually operated spray gun embodying the invention includes a handle through which flow from a pressurized liquid source may pass into a bore. Within the bore, a spool is reciprocally movable by a trigger lever pivotally mounted in the handle. The extent through which the lever is pivoted controls the flow from shutoff (closed or sealed off) to a stream and then to a conically pattern of desired diameter. The spool has a valve at an input end thereof and a flow control element at an output end thereof. The flow control element cooperates with a nozzle. The nozzle has an orifice through which a stream may pass and also has a conical internal surface through which flow from around the outside of the flow control element is guided into a conical pattern. The pivotal motion and extent of pivoting of the lever may be controlled by a mechanism which limits the pivotal motion so that the desired pattern can be obtained. This mechanism may constitute a cam surface which follows by a portion of the lever and is prevented, by virtue of the cam diameter from moving beyond the desired pivotal distance.

The present invention also embodies a spray gun having a chamber having at one end there of an orifice and a conical surface which narrows to the orifice (such as provided by a nozzle), and a spool or tubular member having a rotational axis which is movable longitudinally along such axis within chamber towards and away from the conical surface in which the axis is aligned with the orifice and the conical surface of the chamber. The tubular member having a passageway for inlet of pressurized fluid through the passageway, and a surface enabling flow of pressurized fluid from the passageway in a conical path toward the conical surface of the chamber, such that movement of the surface of the tubular member towards or away from said orifice adjusts the shape of pressurized fluid exiting the spray gun through the orifice.

The foregoing and other objects, features and advantages of the invention will become more apparent from a reading of the following description in connection with the accompanying drawings wherein:

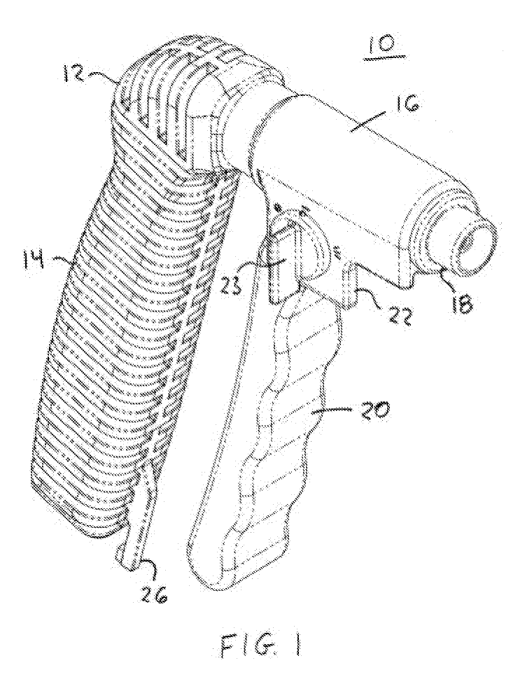

FIG. 1 is perspective view of a spray gun embodying the invention;

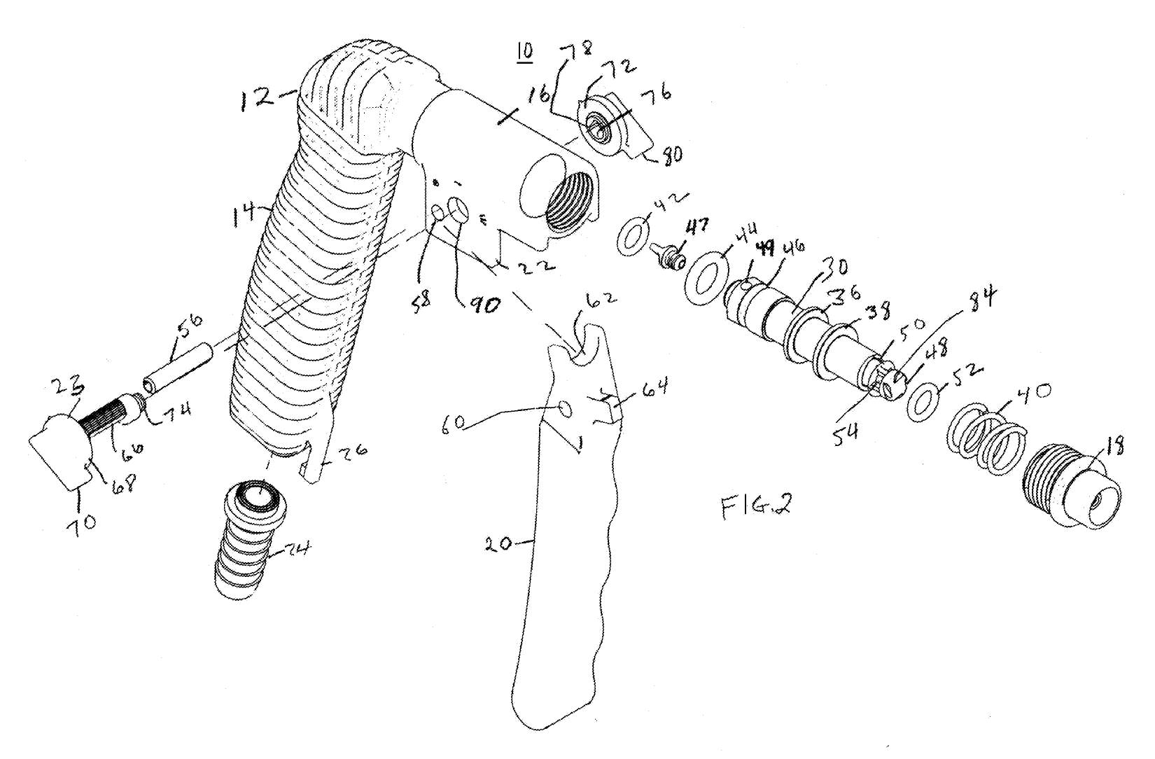

FIG. 2 is a perspective exploded view showing the parts of the spray gun illustrated in FIG. 1;

FIG. 3 is top view of the spray gun shown in FIG. 1;

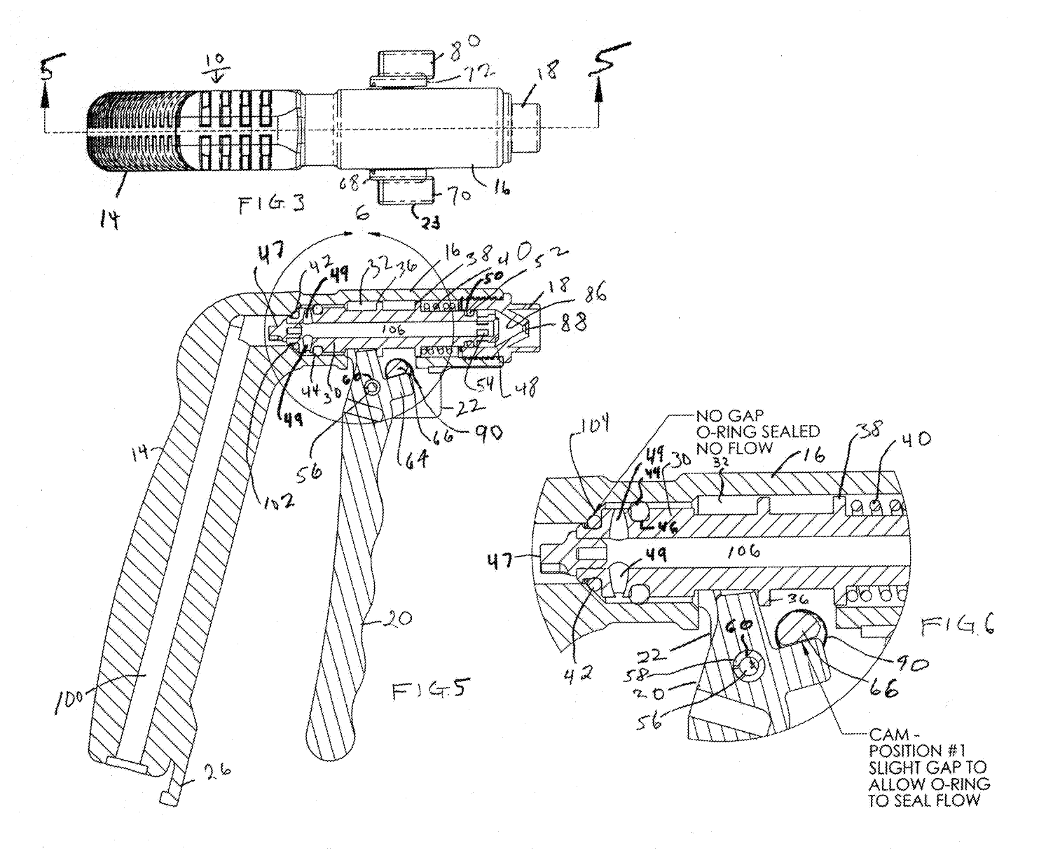

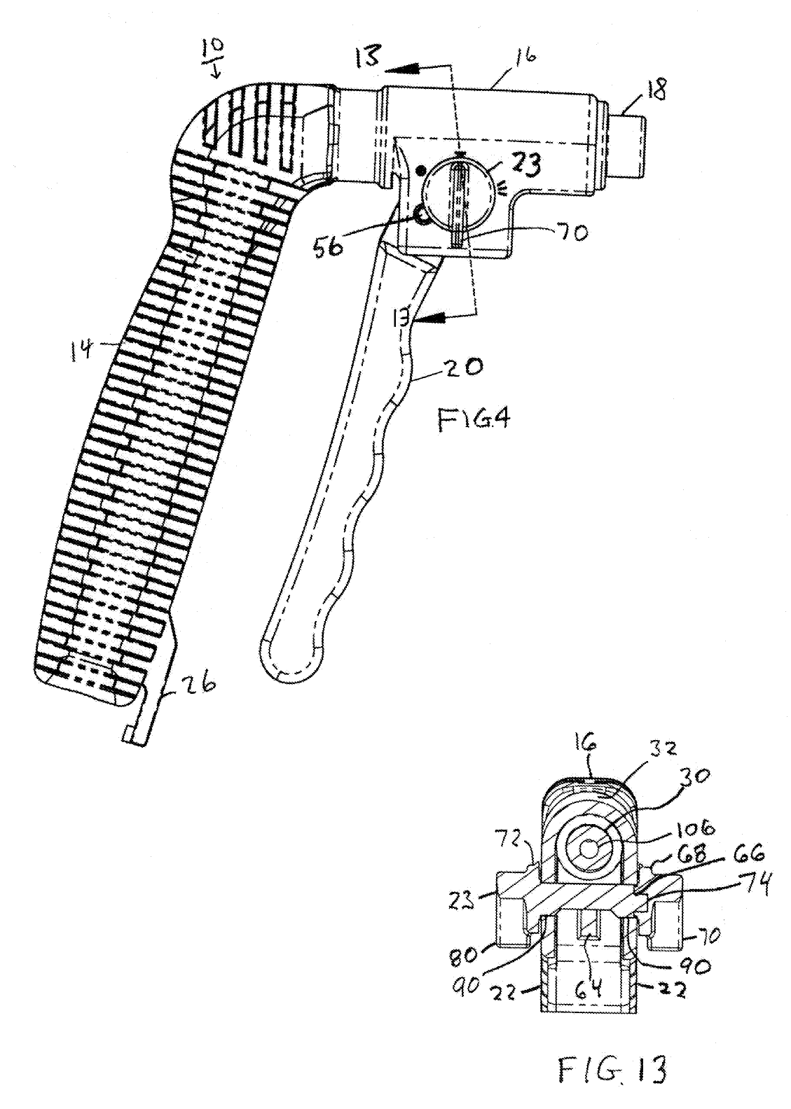

FIG. 4 is a front view from the side of the spray gun shown in FIG. 1;

FIG. 4A is a front view from the side of the spray gun, but with a control mechanism positioned to obtain a stream spray pattern;

FIG. 5 is a sectional view of the spray gun taken along the line 5-5 of FIG. 3 where flow through the spray gun is closed;

FIG. 6 is an enlarged view showing the mechanism for controlling the flow through the spray gun using a trigger lever as well as a cam for controlling the distance through which the trigger lever may rotate;

FIGS. 7, 8, and 9 are views similar to FIGS. 3, 5, and 6, respectively, which show the spray gun in a position to provide a liquid stream through a nozzle at the output end of the spray gun;

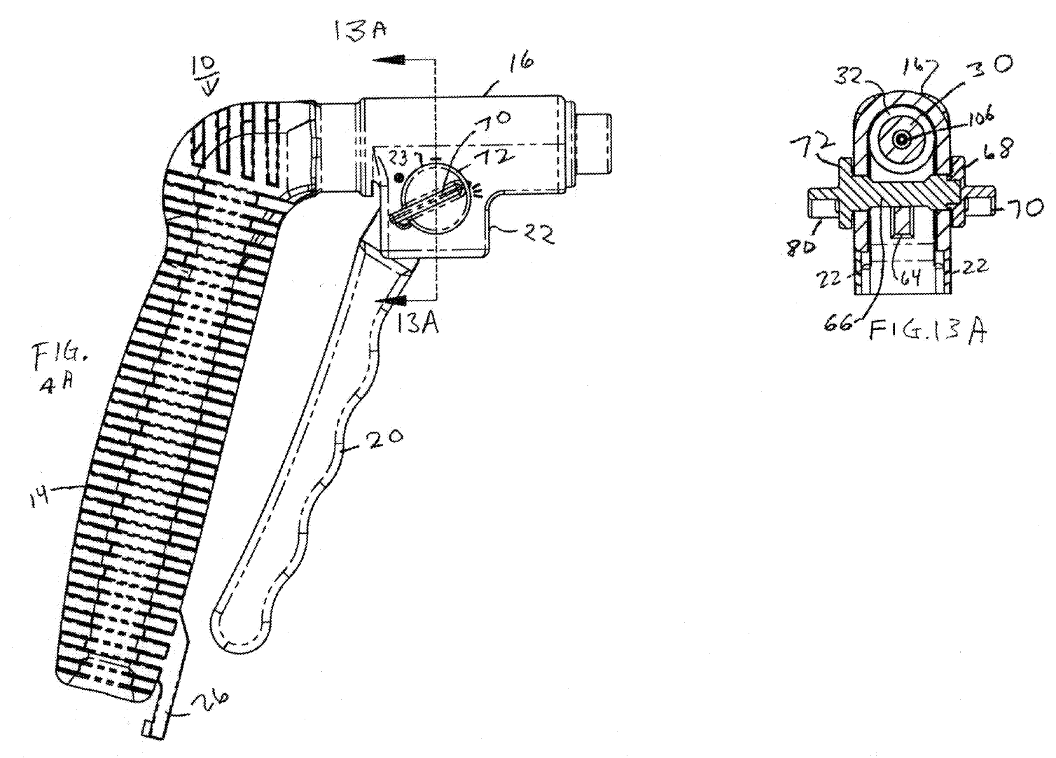

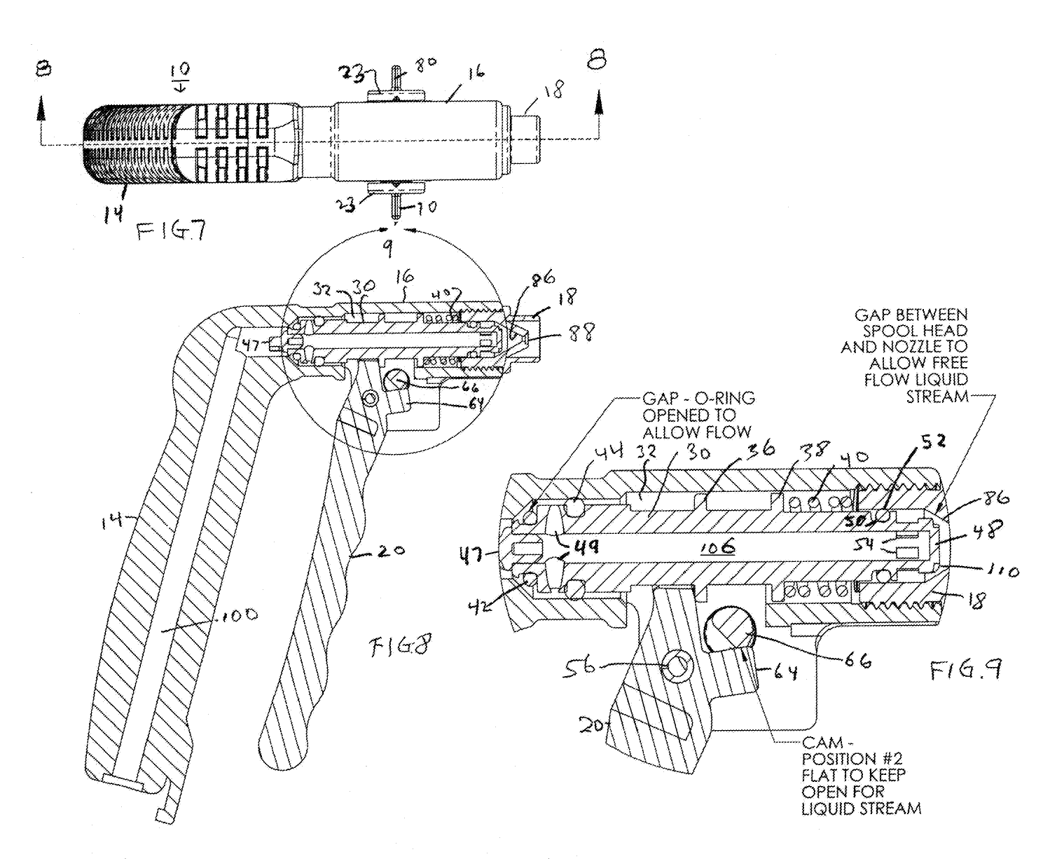

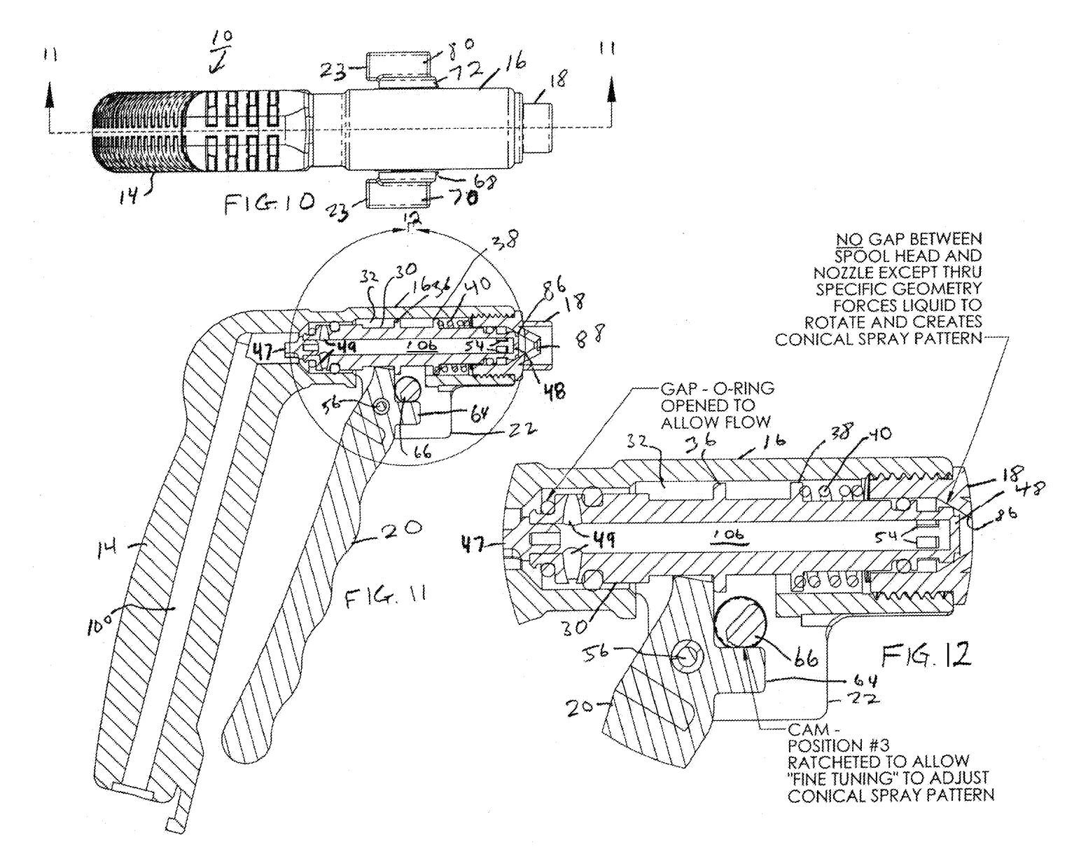

FIGS. 10, 11, and 12 are views similar to FIGS. 3, 5, and 6, respectively, showing the spray gun position to provide an adjustable conical spray pattern;

FIG. 13 is a sectional view along the line 13-13 of FIG. 4, which illustrates a mechanism for controlling the distance through which the trigger lever can pivot so as to obtain either shutoff or a spray pattern which varies from a stream to a conical pattern of selected diameter; and

FIG. 13A is a section view taken along the line 13A-13A of FIG. 4A.

### DETAILED DESCRIPTION OF THE INVENTION

Referring first to FIGS. 1-3, there is shown a spray gun 10 having a handle 12. The handle 12 is made up of a grip portion 14 adapted to be grasped by the palm of the hand of the operator, and a body portion 16 extending there from. A nozzle 18 is attached, such as by screwing, into the front end of body portion 16. A pivotal lever providing a trigger 20 is mounted on a pin 56 extending front skirt portion 22 of the body portion 16. The trigger 20 has indentations at the front thereof for facilitating grasping of the trigger by the fingers of the hand of the operator whose palm engages grip portion 14. A manually rotatable mechanism 23 is rotational mounted in skirt 22 of the body portion 16. The manually rotatable mechanism 23 is described in more detail below to as trigger pivot rotation control mechanism.

As shown in FIG. 2, a hose coupling 24 is secured, such as welded, to the bottom of grip portion 14 of handle 12 and a hose (not shown) is attachable to coupling 24 and engages barbs along the length of the coupling 24. Such hose on coupling 24 is preferably with a sleeve having slots which are secured by means of a spring latch 26. The design of the hose coupling, and a sleeve which provides a nut secured to the end of the hose, is shown in U.S. Pat. No. 5,931,508, issued Aug. 3, 1999 to Clark F. Spriegel, which is incorporated herein by reference.

The design of the spray gun 12 has ornamental features which are the subject matter of a design patent application in the name of the inventors hereof filed concurrently herewith. This ornamental design is characterized at least by an array of slots and ridges on grip portion 14 of handle 12.

The components of the spray gun 10 is shown in FIG. 2 and the assembly thereof is shown in FIGS. 5, 6, 8, 9, 11 and 12. These components include a spool 30 which is movable within a bore or chamber 32 of the body portion 16, as shown in example FIG. 5. The spool 30 is movable between a nozzle 18 which is fixed in position once screwed into the front end of the body portion 16. Unlike the prior art, the nozzle 18 preferably is not rotatable to set the spray gun to a desired spray.

Spool 30 has flanges 36 and 38, which are rings attached to the spool 30 and spaced from each other. One of these rings 38 captures a spring 40. The rear end of the spool 30 captures an O-ring 42. Another O-ring 44 is captured in a groove 46 on the periphery of the spool 30. A plug 47 is screwed into the a threaded rear end of the spool 30 and closes a liquid passage in the form of a bore 106 extending through spool 30. This bore 106 communicates with one of radial slots, openings, or inlet ports 49, such as shown for example in FIGS. 2 and 5. There may be a plurality of slots, for e.g., 4, spaced 90 degrees apart from either other near the rear end of spool 30.

A flow control element 48 is part of the spool 30 and disposed at the front end thereof. A slot 50 behind the flow control element 48 receives another O-ring 52. Slots or outlet ports 54 spaced periphery around the front end of the spool 30 behind the flow control element 48 provide for liquid passage through the bore 106 of spool 30.

Trigger lever 20 is pivotally mounted on a pin 56 extending through skirt 22 of the body portion 16. This pin 56 extends through holes 58 in the two sides of the skirt and is fixed to the skirt. The pin 56 extends through a hole 60 through the upper end of the trigger lever 20. There is a semicircular indentation 62 at the top of the trigger lever so as to provide clearance for trigger lever 20 to pivot about pin 56 without interference with spool 30.

A projection 64 near the upper end of the trigger lever 20 is engagable with a cam shaft 66 of a trigger pivot rotation control mechanism 23. This cam shaft 66 is integrated with a disc 68 having a tab or rib 70 which is engagable by the fingers of the operator to rotate the cam shaft 66 (see also FIGS. 13 and 13A). Another disc 72 having an opening 76 with a flat 78 along one side thereof engages the end 74 of the cam shaft 66 to align the cam shaft with disc 72 when the cam shaft passes through openings 90 in skirt 22 (see FIG. 2). The end 74 of cam shaft 66 may have snap-in connection provided by dimples and indentations on the cam shaft and the surface of an opening 76. This connection enables the cam shaft 66 to snap into one of disc 68 and be rotationally mounted in the skirt 22 of body portion 16. The disc 72 has a finger engagable tab or rib 80 similar to tab or rib 70 to facilitate rotation of cam shaft 66.

As shown in FIG. 2, flow control element 48 has a plurality of slots 84 in a surface thereof which cooperates with nozzle 18 so as to provide for a circular flow path for pressurized liquid leaving the exit port slots 54. These slots 54 provide radially oriented, as opposed to linear flow, to the nozzle 18 so as to facilitate the formation of a conical spray pattern.

As shown in FIG. 5, nozzle 18 has an internal conical surface 86 with an orifice 88 at the apex thereof. This is the orifice through which flow of the liquid passes responsive to pivot of trigger 20. Either stream or conical flow patterns as may be selected by manual rotation of discs 68 and 72, which provides two knobs 28 graspable via tab 70 and/or 80, respectively. Spool 30 may be considered a tubular member having a rotational axis which is movable along such axis within chamber 32 towards and away from nozzle 18 at one end of chamber 32, in which such axis is aligned with orifice 88 and the geometric axis of conical surface 86.

The hose (not shown in FIG. 5) communicates with a liquid passageway 100 through handle 12. The liquid flows through handle grip portion 14 into the bore of the body portion 16 where it encounters a valve 102 at the end of the spool 30. This valve is defined by 0-ring 42 and an inclined circular surface 104 which is part of the bore 32 through body portion 16. Valve 102 is shown closed in FIGS. 5 and 6. Thus flow is inhibited through inlet ports 49 and the passage 106 through the spool 30. The valve 102 at the rear end of spool 30 thereof seals the flow of fluid into the passage 106 through outlet ports 54. The bore 106 in spool 30 is also sealed by the 0-ring 44 so that flow is restricted through passage 106 when the valve 102 in opened.

The cam shaft 66 is positions so as to allow the trigger lever 20 to pivot in a counter-clockwise direction as shown in FIGS. 5 and 6 about pivot pin 56. Spring 40 which bears against the rear end of the nozzle 18 biases spool 30 away form nozzle 18 so that the valve 102 closes passage into bore 106 of spool 30. Spraying from the spray gun 30 is then inhibited.

The location of the part of the spray gun 10 is also shown in the top view of FIG. 3. It will be observed that the tabs 70 and 80 of the trigger pivot rotation control mechanism 23 are in a general horizontal position when the ability of the spray gun 10 to spray liquid is inhibited by stopping flow of pressurized liquid from handle passage 100 through valve 102 into the passage 106 of spool. FIG. 7 illustrates the trigger pivot rotation control mechanism 23 where tabs ribs 70 and 80 are in a generally vertical position. Then the cam shaft 66 is arrange so that trigger 20 may be pivoted forward away from handle grip portion 14 or clockwise in order to open the valve 102 at rear end of spool 30. In this position as shown in FIGS. 7, 8, and 9, spray gun 10 provides a spray pattern in the form of a stream.

Movement of trigger 20 to the position for urging the spool 30 by engagement of trigger 20 with flange ring 36 is limited by cam shaft 66. The spool 30 is moved towards nozzle 18, as shown in FIGS. 8 and 9, against the bias of the spring 40 to a position where the control surfaces 110 of the flow control element 48 (FIG. 9) are spaced a sufficient distance from conical surface 86 of nozzle 18 to permit linear flow of the pressurized liquid through the handle passage 100, the inlet ports 49, and the passage 106 to the spool 30. The flow passes radially through the outlet ports 54 of the spool and then flows linearly along the interior conical surface 86 of the nozzle to the orifice 88, where it exits as a liquid stream. In other words, the spacing of the surface of the flow control element 48 from the nozzle surface 86, that is between the head of spool 30 provided by element 48 and the nozzle 86, allows free flow of the liquid stream and ensures that a liquid stream is outputted from the orifice 88 of the nozzle 18.

Referring to FIGS. 10, 11, and 12, to provide a conical spray pattern from spray gun 10 tabs 70 and 80 of the trigger rotation control mechanism 23 are turned toward the right or in the direction to enable the cam shaft 66 to present its maximum diameter to the cam follower 64 of the trigger 20. The surface of the cam shaft 66 may be ratcheted so as select different amount of rotation, each rotation defines a different diameter of the conical spray pattern, from a full diameter when the spacing of the conical interior surface 86 of the nozzle 18 is less than the spacing when the spray is to be in the form of a stream, as described in connection with FIGS. 7, 8, and 9. Then the flow through flow control end is via slots 54 along the slots 84 of the head of spool 30 defining the flow control element 48 in conjunction with interior conical surface 86 of nozzle 18 to generate an arcuate flow. This arcuate flow of liquid extends through the orifice 88 and out of the orifice in the form of a conical flow pattern. The distance between the flow control element 48 (or head of spool 30) may be changed to control the diameter of the conical spray pattern. In other words, the absence of a gap (or very small gap) between the flow control element 48 the spool head and the nozzle internal conical surface 84 provides a specific geometry which forces the liquid to rotate to create the conical spray pattern.

Referring now to FIGS. 4 and 13, there is shown a position of the trigger pivot rotation control mechanism 23 where the tabs 70 and 80 are vertical so as to provide for the stream pattern. FIGS. 4A and 13A show the trigger pivot rotation control mechanism 23 positioned with the tabs 70 and 80 generally horizontal so as to provide for sealing or shutoff to inhibit flow. The cam shaft 66 is shown in snap in relationship with the disc 68 of the right hand side of the control mechanism, as shown in FIGS. 13 and 13A. The cam surface controls the amount of rotation or pivotal movement of the handle so as to obtain the position of the spool 33 for either shut off or stream operation in FIGS. 4 and 4A, respectively. In either case, the cam follower 64 bears against the cam shaft 66 so as to limit the pivot rotation of the trigger 20 to obtain the desired flow pattern.

In summary of spray gun 10 operation, with application of pressurized fluid to handle passage 100, the trigger pivot rotation control mechanism 23 can rotate the cam shaft 66 to present different diameter stopping surfaces with respect to trigger projection 64, thereby adjusting the forward-most pivot positional extent of the trigger 20 to first, second, and third positions as graphically depicted on the body portion 16 as a circle, dash, and three radial dashes, respectively, which are alignable to tabs 70 and/or 80 by rotation of discs 68 and 72, respectively. At the first position, trigger 20 is set to a forward-most rotational position so that when trigger is pivoted backwards such enables shut-off to a stream and then a conical spray of low to high diameter, and then vise versa in the opposite pivot direction (see FIGS. 3, 5, and 6). At the second position, trigger 20 is set to a forward-most rotational position so that a stream exits spray gun 10, and then if desired further backward pivoting of the trigger 20 can enable a conical spray of low to high diameter (see FIGS. 4, and 7-9). At third position, the forward-most rotational position of trigger 20 is set near the trigger's backward-most rotational position so that a conical spray exits from the spray gun 10, and then if desired further backward pivot of the trigger 20 may enable fine tuning of conical spray diameter (see FIGS. 4A and 10-12). Intermediate positions between or about the first, second, and third positions may also be provided to set the desired forward-most trigger rotational position and thus the spray shape from shut off. Further, mechanism 23 enables the operator to select a desired spray shape or shut off without any manual pressure upon the trigger 20 against the bias of spring 44. Thus, unlike the prior art spray guns utilizing external manual nozzle rotation which often results in operator fluid contact to select desired spray shape or shut off, the operator of spray gun 10 can set the spray gun on to a desired spray shape or shut off without any such possible fluid contact, and if desired, can further control the spray shape from a desired set spray shape, stream or conical, such as at the second or third positions, respectively.

From the foregoing description, it will be apparent that there has been provided an improved spray gun which provides variable and selectable flow patterns depending upon the position of a manually actuable trigger lever. Variations and modifications in the herein described spray gun within the scope of the invention will undoubtedly suggest themselves to those skilled in the art. Accordingly, the foregoing description should be taken as illustrative and not in a limiting sense.

1. A spray gun comprising:
a manually graspable handle on which a trigger lever in pivotally mounted on the handle for rotational movement;
a spool providing a passageway from liquid to be sprayed via a nozzle disposed on said handle;
a valve on said spool at one end thereof;
a spring in said handle which engages said spool biasing said spool to a position closing said spool passageway and inhibiting spraying of liquid from said gun, said spool having, adjacent said nozzle at an end thereof opposite to said one end, a surface cooperating with said nozzle for varying the spray pattern from said nozzle from a stream to a cone depending upon the spacing of said opposite end of said spool from said nozzle, said trigger lever engaging said spool for moving said spool away from said position where said passageway is closed to change said spacing for varying said spray pattern.

2. The spray gun according to claim 1 further comprising a mechanism engagable with said trigger lever for enabling different amounts of rotation of said trigger lever to select said closing position and said different spray patterns from stream to conical spray patterns of different diameter.

3. The spray gun according to claim 1 wherein said mechanism comprises:
a cam shaft engagable with a cam follower projection from said handle said cam shaft being rotatably mounted in said handle to present surfaces of different radius to said follower thereby enabling said trigger lever to move by selected said different amounts.

4. The spray gun according to claim 3 wherein one said cam shaft surfaces which enables selection of a conical spray pattern of varying diameter has a ratcheted surface.

5. The spray gun according to claim 1 wherein said handle has a grip portion extending into a body portion where said nozzle is disposed at an end of said body potion spaced from said grip portion, said nozzle providing an outlet of said spray gun from which said spraying pattern emanates, said spool being movably mounted in said body portion.

6. The spray gun according to claim 5 wherein said valve is defined by a surface of said body portion around said one end of said spool.

7. The spray gun according to claim 5 wherein said nozzle has a conical external surface facing said cooperating surface of said spool at said opposite end thereof, an orifice at the apex of said conical internal surface, said stream pattern emanating from said orifice when said cooperating surface is spaced sufficiently from said conical surface to enable lineal flow of liquid from said spool passageway along said conical surface to said orifice, said cooperating surface having slots therein annularly directed with respect to each other which when said cooperating surface is in adjacent relationship with said conical interior surface of said nozzle directs flow of said liquid arcuately along said conical interior surface an out of said orifice defines said conical spray pattern of different diameter depending upon the proximity of said cooperating surface and said conical exterior surface.

8. A spray gun which is manually operable, said gun comprising:
a handle having a manually gripable portion, a body portion extending from said gripable portion at one end of said body portion;
a nozzle attached to said body portion at and end of said body portion opposite from said the end at said gripable portion;
a trigger provided by a lever pivotally attached to said body portion and disposed along said gripable portion and spaced there from for manual engagement when said gripable portion is manually engaged;
a spool having a flow path through engagable with said trigger and reciprocal by said trigger in said body portion, said spool having opposite ends, said spool providing a valve at one end of said spool, said valve facing a valve seat provided by said body portion at said one end of said spool;
said spool having an end opposite to said valve end and being the head end of said spool, said nozzle having an internal surface facing said opposite head end of said spool, said spool being biased toward said valve seat to close flow though said spool;
said trigger reciprocating said spool from a first position where said valve closes said flow through said spool to position where said head end is spaced selectably is accordance with extent of pivoting of said trigger to provide flow via said spool through said nozzle selectable from a stream to a conical spray pattern.

9. A spray gun comprising:
a chamber;
one end of said chamber having an orifice and a conical surface which narrows to said orifice;
a tubular member having a rotational axis which is movable longitudinally along said axis within said chamber towards and away from said conical surface of said nozzle, in which said axis is aligned with said orifice and said conical surface of said chamber, said tubular member having a passageway for inlet of pressurized fluid through said passageway, and a surface enabling flow of pressurized fluid from said passageway in a conical path toward said conical surface of said chamber, in which movement of said tubular member towards or away from said orifice adjusts the shape of pressurized fluid exiting the spray gun through said orifice.

10. The spray gun according to claim 9 wherein said one end of said chamber is provided by a nozzle having said conical surface and said orifice.

11. The spray gun according to claim 9 where said tubular member is movable responsive to a movable trigger.
